(19) United States
(12) Patent Application Publication
(10) Pub. No.: US 2023/0032946 A1
(43) Pub. Date: Feb. 2, 2023

(54) Extraction Device and Method

(71) Applicant: CAM2 TECHNOLOGIES, LLC, Danbury, CT (US)

(72) Inventors: DAVID W. SCHIERING, Danbury, CT (US); KENNETH C. SCHREIBER, Newtown, CT (US); JAMES J. FITZPATRICK, Newtown, CT (US); ANTHONY W. DIDOMENICO, Danbury, CT (US); JOHN A. SEELENBINDER, Watertown, CT (US); GREGG RESSLER, Shelton, CT (US)

(21) Appl. No.: 17/791,124

(22) PCT Filed: Nov. 19, 2021
(86) PCT No.: PCT/US21/60181

§ 371 Date: Jul. 6, 2022

Related U.S. Application Data
(60) Provisional application No. 63/116,569, filed on Nov. 20, 2020.

(51) Int. Cl. G01N 1/34; G01N 1/40

(52) U.S. Cl. CPC G01N 1/34; G01N 1/4044; G01N 2001/2866

(57) ABSTRACT

A device and method for preparing a sample for solid-liquid or liquid-liquid extraction are provided. In one embodiment, a device includes a sealed container including an opening for receiving a solid sample and a reservoir. The reservoir includes a solvent or is adapted to receive a solvent. The solid sample and the solvent are mixed in the reservoir and to concentrate at least one component of the sample into the solvent within the reservoir. The concentrate is settled into a solvent layer within the container. The solvent layer is sampled via a port. A method includes introducing a solid sample to a solvent; creating a solution by mixing the solid sample with the solvent; allowing the solvent solution to settle into at least one layer; and sampling within at least one layer.

### CROSS-REFERENCE TO RELATED APPLICATIONS

This application claims the benefit of U.S. provisional application No. 63/116,569, filed 20 Nov. 2020, which is hereby incorporated by reference as though fully set forth herein.

### BACKGROUND

### a. Field

The present disclosure relates to a device and method for preparing samples for chemical analyses.

### b. Background

Street drugs, particularly fentanyl derivatives, are encountered in low-dose forms mixed with other drugs, e.g. heroin, and inert materials commonly called ‘cutting agents.’ Fentanyl and its various derivatives are extremely toxic, the lethal dose being 2-3 mg, compared with Heroin at 75 mg. For responder and public health and safety, and for apprehension of drug dealers, it is useful to analyze street drugs in the field and provide immediate situational awareness to reveal a course of action.

Solid-liquid and liquid-liquid extraction are well-known techniques employed in laboratory settings to separate and concentrate materials based on their solubility properties.

### BRIEF SUMMARY

Drugs can be present in pills and powders at low levels and mixed with other, inert materials called ‘cutting agents.’ Cutting agents serve to dilute the drug and make it safer, easier to handle and administer, and sometimes also to increase the profits of the dealer. It is advantageous to separate the drug material(s) from the cutting agents to analyze the drugs separately to reduce the detection limits (the concentration of material in the mixture before extraction) of the analytical method. Embodiments provided herein provide an extraction device and method to separate and concentrate suspect materials in the field, and to introduce the concentrated, separated material to an analysis method. Although described in the context of narcotics drugs materials, the device and method are general and can be applied to other materials, e.g. pharmaceuticals, counterfeit pharmaceuticals, or food products, where concentration might be required to lower limits of detection (LOD).

In one embodiment, a device adapted to integrate sampling and deposition with solid-liquid or liquid-liquid extraction in an integrated device.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a flow chart of an embodiment of an extraction method.

FIG. 2 is a graph showing an example analysis of a preconcentrated, extracted sample.

FIGS. 3A-3C are views of an embodiment of an extraction device.

FIGS. 4A-4D are views of embodiments of an extraction device.

FIGS. 5A-5B are flow charts of embodiments of extraction methods.

FIG. 6 is a view of an embodiment of an extraction device.

FIGS. 7A-7C are views of an embodiment of an extraction device.

FIGS. 8A-8C are views of an embodiment of an extraction device.

FIGS. 9A-9C are views of an embodiment of an extraction device.

FIGS. 10A-10C are views of an embodiment of an extraction device.

### DETAILED DESCRIPTION

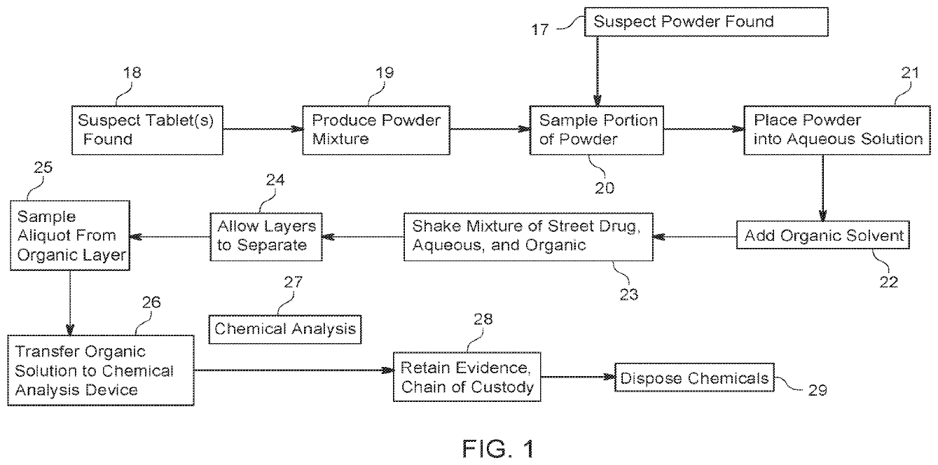

FIG. 1 is a flow chart of an embodiment of an extraction method. FIG. 1 illustrates steps in an embodiment of an extraction method as might be employed in a laboratory using laboratory equipment. Embodiments provided herein can be adapted to simplify the procedure and accomplish sampling, extraction, concentration, and introduction into or on a device that can be deployed to the field, outside of a laboratory setting.

In FIG. 1 an input sample can be received in one or more forms, such as in a tablet 18 or powder 17 or some other undivided solid form. If in a tablet form 18, a powder mixture can be obtained 19 such as by crushing, abrading, or cutting the tablet. A sampled portion of the powder 20 is placed into a solvent 21, such as an aqueous solution, and mixture is then shaken or otherwise agitated to mix the powder and the solvent (e.g., aqueous solution), and to dissolve the portion of the sample containing the chemical of interest that is to be analyzed. A second solvent immiscible with the first solvent, such as an organic solvent, is added 22. The mixture is then shaken or otherwise agitated 23 to mix the powder, first solvent (e.g., aqueous solution), and second solvent immiscible with the first solvent (e.g., organic solvent). The mixture is allowed to settle so that it can separate into immiscible solvent layers 24. A sample aliquot is taken from one of the layers 25, such as an organic solvent layer, by sampling within the layer including the second solvent. The sampled solvent solution (e.g., organic solvent solution) is deposited onto a sensor/substrate or into a chamber, or a sample introduction inlet 26 and a chemical analysis 27 is performed. The analysis methods can include spectroscopy, chromatography, gravimetric, colorimetric, and any other chemical analysis method known in the art. In a legal setting, chain of custody 28 can be maintained, and the sample can be disposed of 29 or stored depending on the process requirements.

In one embodiment, street drugs may be found as powdered mixtures or in pill or tablet form. Systems and methods are provided for analyzing one or both types. A contemporary problem is counterfeit oxycodone tablets. These tablets contain fentanyl derivatives, sometimes other narcotics like heroin, acetaminophen, and other inert materials. Typically, the concentration of the fentanyl is 1% by weight or less. At this concentration, the presence of other materials in the tablet can hinder the direct analysis of fentanyl in these tablets. Referencing the process flow in FIG. 1, these counterfeit oxycodone tablets can be analyzed for the presence of fentanyl, fentanyl derivatives, or other narcotics. In one example, the extraction, concentration, and deposition procedure for a counterfeit oxycodone tablet that contains fentanyl HCl salt is described, but the same procedure could be used for any type of powder sample, including but not limited to other street drugs including heroin, cocaine, and methamphetamine.

In an example method, the tablet or other undivided solid is crushed or abraded or otherwise processed to produce a powder that can more efficiently be dissolved. This step is optional if a street drug is encountered as a powder or other dissolvable form. A portion of the powder is sampled and then dissolved in a solvent, such as an aqueous medium that is basic if HCl salts are to be analyzed. Not all materials will necessarily dissolve in an aqueous medium, but the HCl salts will dissolve. Next, the aqueous medium is extracted with a second solvent immiscible with the first solvent, such as an organic solvent. There are numerous solvents that could be used. A solvent that is denser than water, e.g. chloroform (CHCl3), is used in some embodiments but is not required. The volumes of aqueous and organic solvents in one embodiment are typically about 0.5 ml. The chloroform solvent is added to a vessel that contains the first aqueous solvent medium with dissolved fentanyl. The vessel is shaken vigorously to extract soluble material into the organic (chloroform) solvent. The aqueous and organic phases are allowed to separate. In the case of chloroform, the organic phase will be below the aqueous phase. A portion of the chloroform extract is sampled using a syringe, micropipet, laboratory dropper, a porous medium, etc. The amount of liquid sampled will depend on the analysis method used. For Fourier transform infrared (FTIR) spectroscopy using attenuated total reflection (ATR), less than 100 μl of solution is needed. The solution is deposited on a substrate, for FTIR, the ATR internal reflection element (IRE). The solvent is allowed to evaporate leaving the extracted residue on the sensor surface. This extracted residue is then analyzed for the presence of fentanyl. Typically, the sampled tablet, extraction solutions, are packaged and retained for evidence. Finally, the excess chemicals and other equipment is cleaned or thrown away.

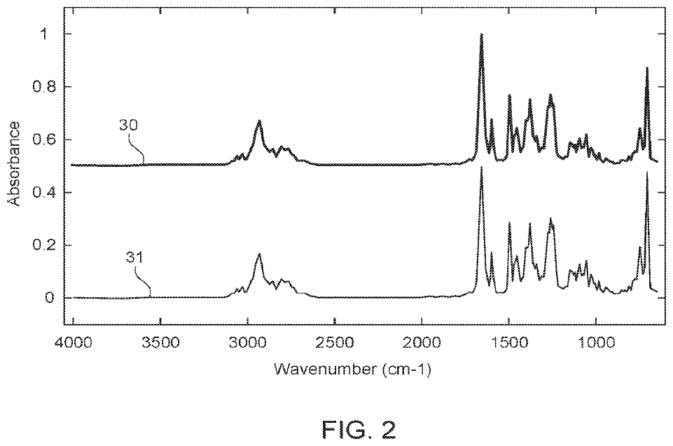

An example analysis of a preconcentrated, extracted sample is shown in FIG. 2. In this example, the sample consisted of 1% by weight of fentanyl hydrochloride (HCl) mixed with acetaminophen, a common counterfeit oxycodone tablet composition. The fentanyl free base was produced and extracted into the organic phase 24, in this case chloroform (CHCl₃), according to the method shown in FIG. 1. A preconcentrated, isolated sample aliquot 25, of a volume less than 100 microliters (μl), was transferred 26 to the surface of an attenuated total reflection (ATR) interface of a Fourier transform infrared (FT-IR) spectrometer and an infrared (IR) spectrum of the extracted fentanyl 31 recorded. The identity of the fentanyl is determined by comparison with the IR spectrum of a known sample of fentanyl 30. The comparison may be automated using computer searching and comparison methods that are well known in the art. An example FT-IR spectrometric analysis is shown, but the liquid-liquid extraction method can be used with many other chemical analysis techniques including, but not limited to, gas chromatography (GC), liquid chromatography (LC), Raman spectroscopy, ultraviolet-visible (UV-Vis) spectroscopy, nuclear magnetic resonance (NMR) spectroscopy, atomic spectroscopy, colorimetric analysis, or gravimetric analysis.

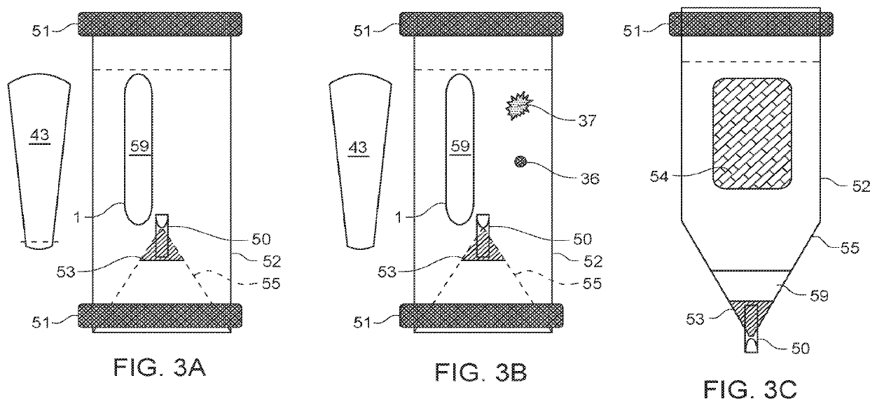

Liquid-liquid extraction is described above, but with minor alteration, the delineated embodiments of the extraction device can be used for solid-liquid extraction, the extraction of chemicals of interest directly from solid samples. In solid-liquid extraction, a single solvent or miscible solvent mixture is used to extract chemicals of interest directly from a solid sample that is ideally finely divided or powdered in nature. The solvent can be aqueous or non-aqueous. One such example device is presented in FIGS. 3A-3C. This embodiment integrates the tablet or undivided solid crushing, powder sampling, solid-liquid extraction, and deposition in a formed plastic bag container, as illustrated in FIGS. 3A-3C. In this embodiment, a container or vessel 52 is formed from a pliable, deformable tube that could be plastic in nature.

FIG. 3A illustrates the device as received, prior to inserting the sample. The ends of the container are sealed with removeable clamps 51. The solvent 59 is prefilled in a vial or ampoule 1 that is sealed in the container 52 by the removeable clamps 51. The solvent 59 can be aqueous or non-aqueous in nature. A nib 50 is sealed into one end of the container 52 that is formed in the shape of a funnel 55. Desiccant or drying agent 53 is preloaded into the end of the funnel 55 over the nib 50. As the device is received, both ends of the container or vessel 52 are folded and clamped with the removeable clamps 51 to seal the prefilled vial or ampoule 1 for shipment. A separate pestle 43 is provided to crush a tablet 36 or produce a powder 37 from a solid sample.

FIG. 3B shows the plastic bag container with samples inserted. Prior to placing the samples in the bag container 52, the clamp 51 at the upper end of the container, where the funnel 55 is not located, is removed. A tablet or undivided sample 36 or powder sample 37 is placed in the container 52 and the bag resealed at the top of the bag with the removeable clamp 51. The pestle 43 is used to crush a tablet or other solid sample through the pliable container wall to produce powder 19 within the sealed container or vessel 52. The tablet is crushed with the pestle by applying force to the outside of the bag as the bag is resting on a hard surface that provides the function of the mortar. While both clamps seal the ends of the container, the pestle 43 is used to crush the vial 1 containing the solvent 59. The sealed container is shaken or agitated to dissolve the soluble portion of the chemical sample for chemical analysis.

FIG. 3C illustrates the plastic bag container when ready for deposition of the sample for chemical analysis. The insoluble portion of crushed, powdered sample remains in the bag along with the crushed shards 54 of the glass vial or ampoules used to contain the solvent. The removeable clamp 51 at the bottom of the bag is removed and the bag is oriented with the nib 50 pointing downwards. The solvent that contains the extracted chemical(s) forms a layer 59 at the bottom of the bag in the funnel 55. If the solvent to be used is organic in nature, a desiccant or drying agent 53 is preloaded in the funnel. The desiccant or drying agent is used to remove residual water from the extracted material. If an aqueous solvent is used, desiccant or drying agent 53 is not preloaded. The solvent 59 phase is allowed to flow through the preloaded desiccant or drying agent 53 to the nib 50. The desiccant or drying agent 53 removes any residual water from the organic phase. The residual water may prevent a successful chemical analysis. The anhydrous organic phase is allowed to flow through the nib 50, a porous material that controls the liquid flow rate. Drops of the anhydrous organic phase flowing out of the nib are transferred to the chemical analysis device 26 for chemical analysis 27. After deposition, the removeable clamp 51 can be used to reseal the bottom portion of the bag container or vessel 52. The sample, used solvents, and crushed vials can be retained for evidentiary purposes 28 or discarded 29. If the solvent is aqueous in nature, the same procedure is used with the elimination of the desiccant or drying agent 53.

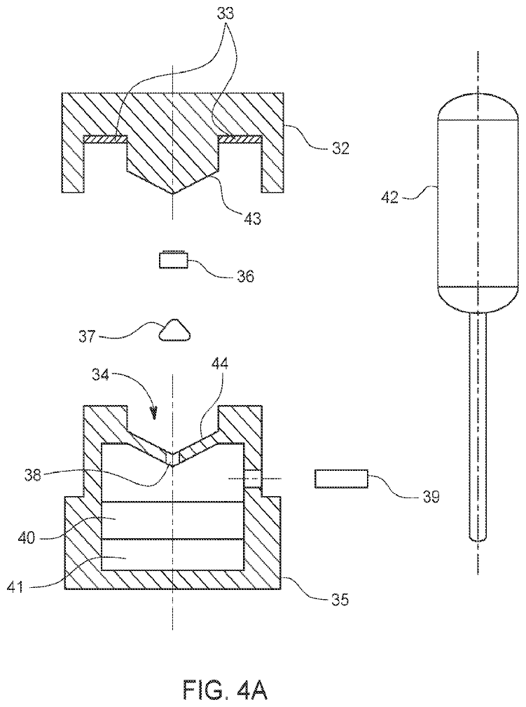

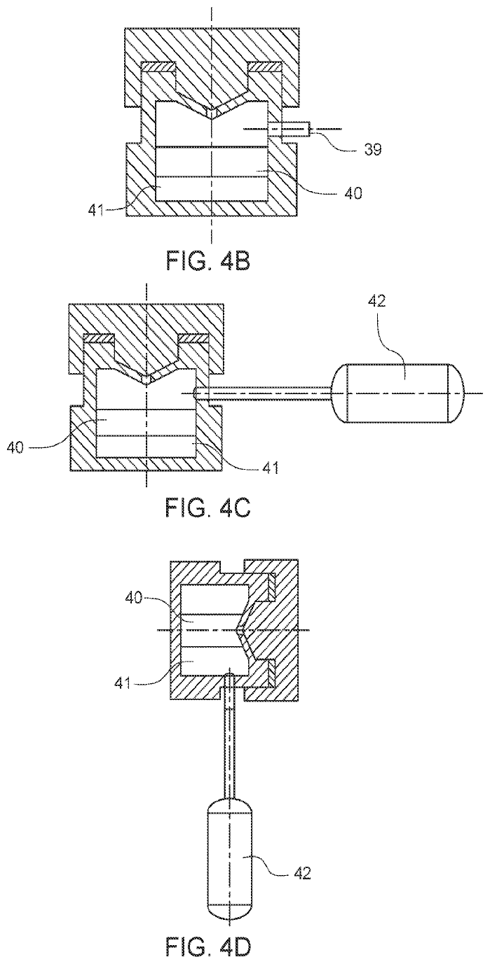

In one embodiment, a device provides an integrated solution to perform the liquid-liquid extraction process using relatively few components, in a low-cost, disposable package, enabling the extraction method in the field, out of the laboratory. FIG. 4A illustrates the components of one example embodiment of a device. This embodiment makes use of an extraction vessel that also serves to sample a tablet, undivided solid, divided solid, or powder. The extraction vessel has a removeable twist cap 32 that is threaded to secure and seal the top part of the vessel to the bottom pre-filled mixing vessel 35. The top of the cap incorporates a gasket 33 to seal the device for shipment, accomplishing the extraction, and saving or disposing of the chemicals after the extraction and deposition is complete. A removeable plug 39, shown at the side of the bottom part of the vessel, retains the solvents used in the extraction. The bottom part of the vessel is pre-filled with at least two immiscible solvents, in this example aqueous 40 and organic 41 liquids, used for the chemical extraction. Incorporated in the vessel cap 32 acting together with the bottom of the vessel is a pill or tablet crusher 43, top 32 and bottom 35 parts acting as a pestle 43 and mortar 44. While the top part of the vessel 32 is removed, a tablet 36, or portion thereof, is placed in the conical receptacle, sample chamber 34 in the bottom part of the vessel 35. To affect the crushing and grinding of the tablet and production of powder sample 19, the vessel cap 32 is rotated using finger pressure along the threads until sealed against the gasket 33. In the top of the vessel containing the liquids is the pestle 43. The mortar 44 has holes 38 that permit the powdered sample to fall through into the liquid chamber, as the tablet is ground. In an alternative implementation, the bottom of the mortar can be a grater (e.g., a metal grater). In this implementation the fine particulate sample falls through the holes in the grater. The powder or fine particulates fall into the liquid 40, 41, 21 in the vessel. The vessel cap 32 is secured and sealed with the gasket 33.

FIG. 4B illustrates the secured and sealed vessel with sample. In this example, the vessel can stand, such as for one minute, so that the solid material dissolves 21 in the aqueous medium 41. Next, the sealed vessel is shaken vigorously 23 for about 30 seconds. The vessel is allowed to stand, such as for an additional minute and the aqueous and organic layers separate 24. If the sample is a street drug that contains an HCl salt form and the aqueous medium is basic, the narcotic is converted to the base form and preferentially partitions in the organic phase due to the base form solubility properties. Other components of the sample, for example the cutting agents, can be largely insoluble in the organic phase and stay behind in the aqueous phase.

FIG. 4C illustrates the insertion of the dispenser into the extraction vessel. While the extraction vessel is sealed, on a level surface, the orifice plug 39 is removed. A plastic, disposable laboratory pipet dispenser 42 is inserted into the orifice from which the orifice plug 39 was removed. The pipet tip seals against the vessel wall. Other dispensers may also be used, including syringes or droppers. In this embodiment, the organic layer is illustrated for the case where the organic solvent 41 is denser than the aqueous solvent 40 and the organic solvent 41 is in the bottom of the vessel. In other cases the organic layer 41 is less dense than the aqueous layer 40, e.g. hexane, and the organic phase 41 will be above the aqueous phase 40. In this latter case, a minor modification to this embodiment, the placement of the orifice and orifice plug 39 to coincide with the upper layer, is provided. In all cases, the dispenser pipet 42 will be used to draw the phase of interest out of the vessel.

FIG. 4D shows the insertion of the dispenser 42 into the side of the extraction vessel and the positioning of the vessel to withdraw the sample aliquot 25 from the organic layer 41. Some portion of the organic layer is sampled for analysis. Liquid from the organic layer is drawn using the dispenser pipette 42. With the pipette inserted and sealed against the vessel wall, the sealed vessel is oriented with the orifice facing downwards, as shown in FIG. 4D. In this orientation, the denser layer 41 is in the closest proximity to the pipette tip. A portion of the bottom layer is drawn from the vessel into the dispenser pipette 42. The vessel is then placed on a level surface, the pipette withdrawn, and the orifice re-sealed with the orifice plug 39. The device may also include a stop or other device adapted to aid in aligning the pipette or other sampling device with a layer 40, 41 to be sampled.

The solution contained in the pipette is introduced 26 to a method to analyze the solute. One such method is Fourier transform infrared (FTIR) spectroscopy. In this case, less than 100 μl of liquid, corresponding to a drop or two (2), is deposited 26 on the diamond internal reflection element (IRE) of an ATR sample interface. The solvent evaporates, leaving the analyte on the diamond surface for analysis 27. Another method is surface-enhanced Raman spectroscopy (SERS). Various SERS substrates are known. A few drops of the liquid are deposited 26 on the SERS substrate and a Raman spectroscopic analysis is performed. Wet chemical analyses may also be performed. These assays are typically colorimetric. A few drops of the organic liquid are added 26 to reagents, a color change indicates 27 the presence of a chemical of interest. Other methods that could be used to analyze these extracted drops include gas chromatography (GC), liquid chromatography (LC), gas chromatography/mass spectrometry (GC/MS), liquid chromatography/mass spectrometry (LC/MS), nuclear magnetic resonance (NMR) spectroscopy, ultraviolet-visible (UV-VIS) spectroscopy, or colorimetric or gravimetric analysis.

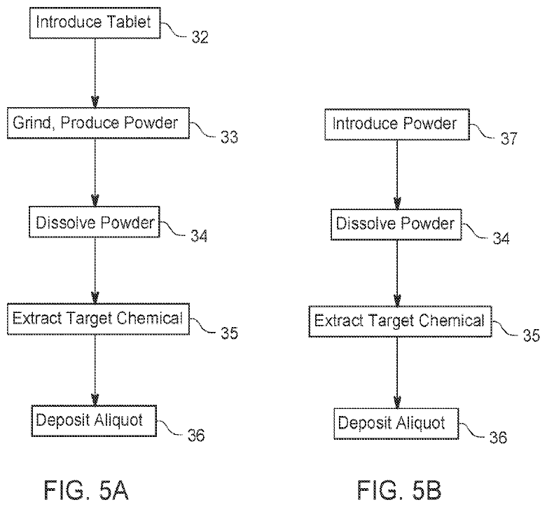

FIGS. 5A-5B illustrates the integrated tablet grinding, powder production, dissolution, extraction, and sample deposition method enabled by the extraction device. In this embodiment, two scenarios exist. FIG. 5A illustrates a situation where the sample requires reduction to particulates to promote dissolution. A tablet or otherwise undivided solid sample is placed in the device 32. A pestle 43 or other means is used to grind or abrade the solid material to produce particulates or powder 33. The chemical of interest in the powder or particulates is dissolved in solvent 34. The target chemical is extracted 35 into a solvent and finally an aliquot of the solution is deposited into an analytical device or method 36. FIG. 5B illustrates a case where a powder or particulate sample is directly inserted into the device 37. The chemical of interest in the powder or particulates is dissolved in solvent 34. The target chemical is extracted 35 into a solvent and finally an aliquot of the solution is deposited into an analytical device or method 36.

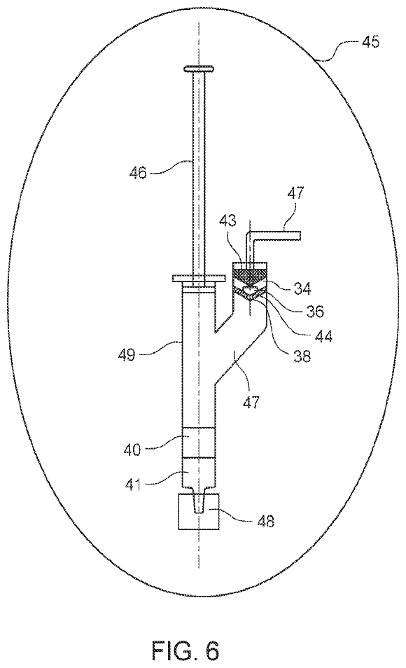

Other embodiments of an extraction device can also be used. One such example is shown in FIG. 6. Incorporation of the tablet crushing 19, powder sampling 20, and extraction into a dispenser 25 is envisioned in this embodiment 45, a dual port syringe mechanism. The syringe mechanism is prefilled with solvents 40, 41 and sealed with a stopper 48 until the extracted sample is dispensed. A tablet crusher, powder sampler mechanism includes a sample chamber 34, crusher handle 47, pestle 43, mortar 44, and holes or a screen 38 that allow the powdered sample 37 to transport to the liquids 40, 41. The tablet crusher is also used also to introduce powder samples 37. In this embodiment, the powder sample is introduced to the liquid phase 21 via a chute 47. The syringe assembly 45 is agitated 23 and allowed to settle 24 until the chemical of interest partitions between the aqueous 40 and organic phases 41. The extraction is performed within the syringe dispenser 45. Drops from syringe are introduced to the analytical method 26 by depressing the syringe plunger 46 to eject aliquot drops of the denser solvent 41 to introduce the chemical of interest to an analytical method 26.

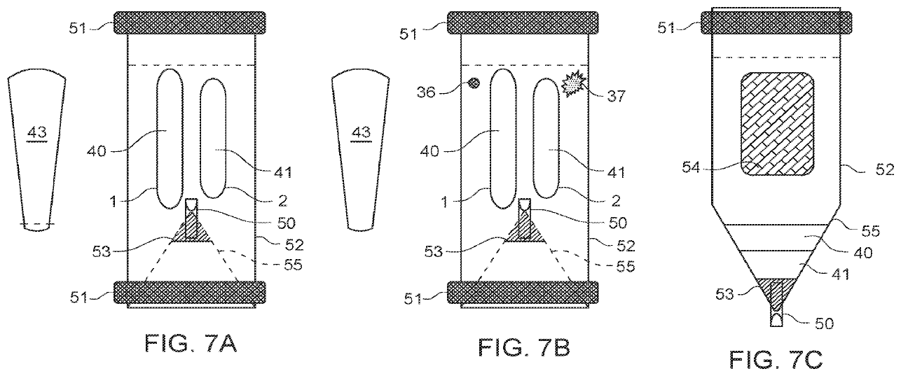

Another embodiment integrates the tablet crushing, powder sampling, liquid-liquid extraction, and deposition in a formed plastic bag container, as illustrated in FIGS. 7A-7C. In this embodiment, a container or vessel 52 is formed from a pliable, deformable tube that could be plastic in nature.

FIG. 7A illustrates the device as received, prior to inserting the sample. The ends of the container are sealed with removeable clamps 51. The immiscible solvents 40, 41 are prefilled in vials or ampoules 1, 2 that are sealed in the container 52 by the removeable clamps 51. A nib 50 is sealed into one end of the container 52, that is formed in the shape of a funnel 55. Desiccant or drying agent 53 is preloaded into the end of the funnel 55 over the nib 50. As the device is received, both ends of the container or vessel 52 are folded and clamped with the removeable clamps 51 to seal the prefilled vials or ampoules 1, 2 for shipment. A separate pestle 43 is provided to crush a tablet or undivided solid 36 or produce a powder 37 from a solid sample.

FIG. 7B shows the plastic bag container with samples inserted. Prior to placing the samples in the bag container 52, the clamp 51 at the upper end of the container, where the funnel 55 is not located, is removed. A tablet 36 or powder sample 37 is placed in the container 52 and the bag resealed at the top of the bag with the removeable clamp 51. The pestle 43 is used to crush a tablet or other solid sample through the pliable container wall to produce powder 19 within the sealed container or vessel 52. The tablet is crushed with the pestle by applying force to the outside of the bag as the bag is resting on a hard surface that provides the function of the mortar 44. While both clamps seal the ends of the container, the pestle 43 is used to crush the vial 1 containing the aqueous solvent 40. The sealed container is shaken or agitated to dissolve the soluble portion of the chemical sample for chemical analysis. While both clamps seal the ends of the container, the pestle 43 is used to crush the vial 2 containing the organic solvent 41. The sealed container is shaken or agitated to extract the soluble portion of the chemical sample into the organic solvent.

FIG. 7C illustrates the plastic bag container when ready for deposition of the sample for chemical analysis. The insoluble portion of crushed, powdered sample remains in the bag along with the crushed shards 54 of the glass vial or ampoules used to contain the solvent. The removeable clamp 51 at the bottom of the bag is removed. The immiscible solvents form layers 24 in the funnel 55 at the bottom portion of the bag. The organic phase is allowed to flow through the preloaded desiccant or drying agent 53 to the nib 50. The desiccant or drying agent removes any residual water from the organic phase. The residual water may prevent a successful chemical analysis. The anhydrous organic phase is allowed to flow through the nib 50, a porous material that controls the liquid flow rate. Drops of the anhydrous organic phase flowing out of the nib are transferred to the chemical analysis device 26 for chemical analysis 27. After deposition, the removeable clamp 51 can be used to reseal the bottom portion of the bag container or vessel 52. The sample, used solvents, and crushed vials can be retained for evidentiary purposes 28 or discarded 29.

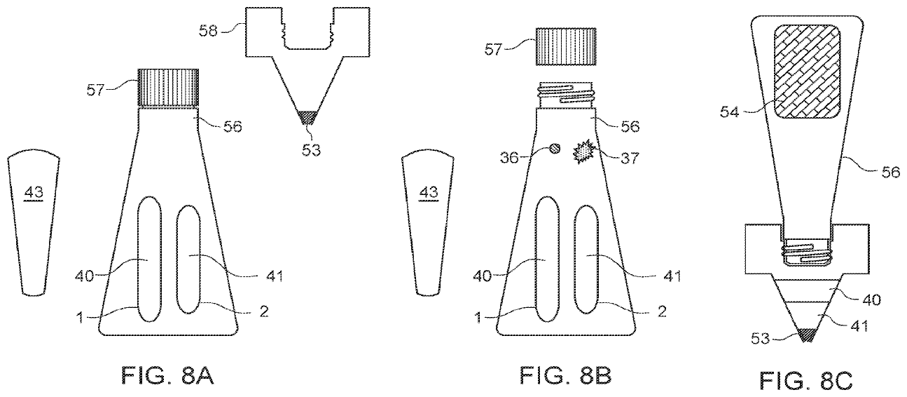

Another example embodiment that incorporates tablet crushing, powder sampling, liquid-liquid extraction, and deposition into a single container is shown in FIGS. 8A-8C. In this embodiment, a container or vessel includes a pliable, deformable tube container 56 that is permanently sealed at one end and threaded at the other end to attach a sealing cap 57 or cap dispenser 58.

FIG. 8A illustrates the device as received, prior to inserting the sample. The container is sealed with the removeable sealing cap 57. The immiscible solvents 40, 41 are prefilled in vials or ampoules 1, 2 that are sealed in the container 56 by the removeable sealing cap 57. A separate pestle 43 is provided to crush a tablet 36 or produce a powder 37 from a solid sample. A bottle cap dispenser 58 that is prefilled at the dispenser tip with desiccant or drying agent 53 is included as a separate item.

FIG. 8B shows the tube container 56 with samples inserted. Prior to placing the samples in the tube container 56, the sealing cap 57 is removed. A tablet 36 or powder sample 37 is placed in the tube container 56 and resealed with the sealing cap 57. The pestle 43 is used to crush a tablet or other solid sample through the pliable container wall to produce powder 19 within the sealed tube container or vessel 56. The tablet is crushed with the pestle by applying force to the outside of the bag as the bag is resting on a hard surface that provides the function of the mortar 44. While the sealing cap 57 seals the container, the pestle 43 is used to crush the vial 1 containing the aqueous solvent 40. The sealed container is shaken or agitated to dissolve the soluble portion of the chemical sample for chemical analysis. While the sealing cap 57 seals the tube container, the pestle 43 is used to crush the vial 2 containing the organic solvent 41. The sealed container is shaken or agitated to extract the soluble portion of the chemical sample into the organic solvent 41.

FIG. 8C illustrates the tube container when ready for deposition of the sample for chemical analysis. The insoluble portion of crushed, powdered sample remains in the tube container 56 along with the crushed shards 54 of the glass vial or ampoules 1, 2 used to contain the solvent. A bottle cap dispenser 58 that is prefilled at the dispenser tip with desiccant or drying agent 53 is attached to the tube container 56. The immiscible solvents form layers 24 in bottle cap dispenser 58 at the bottom portion. The organic phase is allowed to flow through the preloaded desiccant or drying agent 53 to the tip of the bottle cap dispenser 58. The desiccant or drying agent removes any residual water from the organic phase. The residual water may prevent a successful chemical analysis. The anhydrous organic phase is allowed to flow out through the bottle cap dispenser 58. Drops of the anhydrous organic phase flowing out of the bottle cap dispenser 58 are transferred to the chemical analysis device 26 for chemical analysis 27. After deposition, bottle cap dispenser 58 can be removed and the removeable sealing cap 57 can be used to reseal the tube container or vessel 56. The sample, used solvents, and crushed vials can be retained for evidentiary purposes 28 or discarded 29.

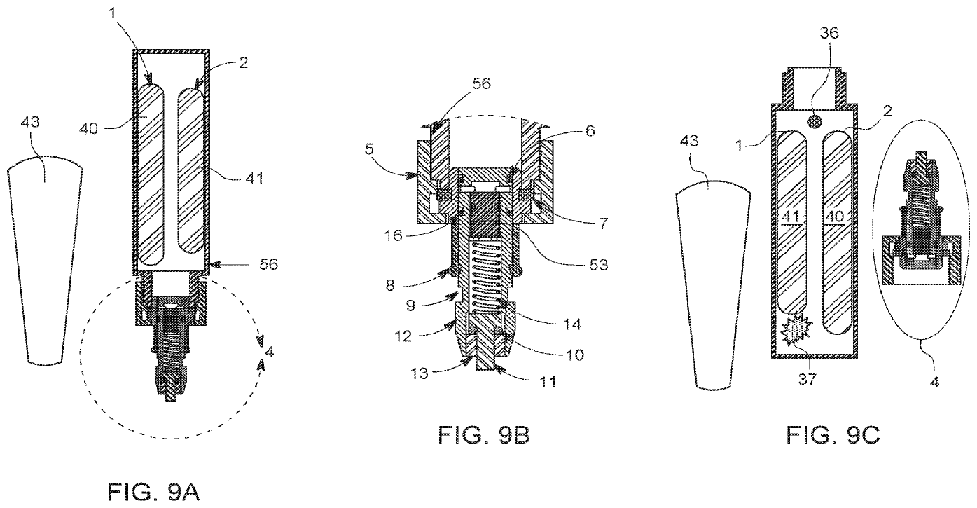

Another example embodiment that incorporates tablet crushing, powder sampling, liquid-liquid extraction, and deposition into a single container is shown in FIGS. 9A-9C. In this embodiment, a container or vessel consists of a pliable, deformable tube container 56 that is permanently sealed at one end and threaded at the other end to attach a valve dispenser 4.

FIG. 9A illustrates the device as received, prior to inserting the sample. The container is sealed with the valve dispenser 4. The immiscible solvents 40, 41 are prefilled in vials or ampoules 1, 2 that are sealed in the container 56 by the valve dispenser 4. A separate pestle 43 is provided to crush a tablet 36 or produce a powder 37 from a solid sample.

FIG. 9B shows the details of the valve dispenser 4. The valve dispenser 4 connects to the tube container 56 using a threaded connection in the valve dispenser cap 5 and a liquid-tight seal is formed between the tube container 56 and valve dispenser 4. The holder 12 acts to maintain the various seals, contains the internal valve dispenser mechanism, and participates in the valve dispenser function. The valve dispenser is prefilled with desiccant or drying agent 53. The desiccant seal 6 keeps liquid from entering the desiccant chamber until the valve is actuated. The tube-dispenser seal is affected by a seal gasket 7, container seal 16, the retainer 13, and plunger seal 10. The operation of the valve dispenser relies on an internal spring 14, valve spring position clip 8, valve position stop notch 9, and plunger 11.

FIG. 9C shows the tube container 56 with samples inserted. Prior to placing the samples in the tube container 56, the valve dispenser 4 is removed. A tablet 36 or powder sample 37 is placed in the tube container 56 and resealed with the valve dispenser 4. The pestle 43 is used to crush a tablet or other solid sample through the pliable container wall to produce powder 19 within the sealed tube container or vessel 56. The tablet is crushed with the pestle by applying force to the outside of the bag as the bag is resting on a hard surface that provides the function of the mortar 44. While the valve dispenser 4 seals the container, the pestle 43 is used to crush the vial 1 containing the aqueous solvent 40. The sealed container is shaken or agitated to dissolve the soluble portion of the chemical sample for chemical analysis. While the valve dispenser 4 seals the tube container, the pestle 43 is used to crush the vial 2 containing the organic solvent 41. The sealed container is shaken or agitated to extract the soluble portion of the chemical sample into the organic solvent 41.

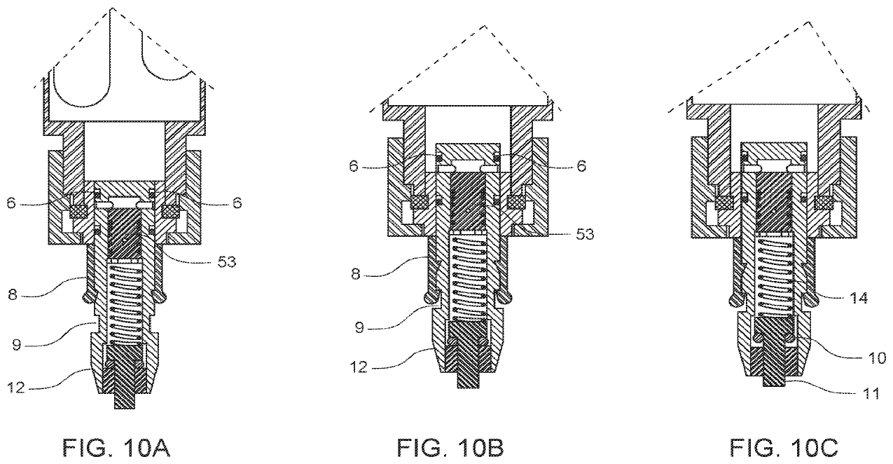

FIGS. 10A-10C illustrate the operation of valve dispenser 4 when ready for deposition of the sample for chemical analysis. The insoluble portion of crushed, powdered sample remains in the tube container along with the crushed shards 54 of the glass vial or ampoules 1, 2 used to contain the solvent. The valve dispenser 4 that is prefilled with desiccant or drying agent 53 is attached to the tube container 56. The immiscible solvents form layers 24 in the tube container 56. FIG. 10A shows the valve dispenser prior to beginning the process of dispensing the solvent with the extracted chemical of interest. All the seals and valves are positioned to retain the solvent in the tube container at the head of the valve dispenser 4. As shown in the orientation in FIG. 10B, the holder 12 is engaged and forced upwards. The valve spring position clip 8 moves downward until retained in the valve position stop notch 9. The holder 12 may be engaged using finger pressure applied externally to the holder 12 until the valve spring position clip 8 is retained in the valve position stop notch 9. Alternatively, force may be applied to the holder 12 by pressing the valve dispenser assembly 4 against a surface until the valve spring position clip 8 is retained in the valve position stop notch 9. In either of these cases, when the valve spring position clip 8 is retained in the valve position stop notch 9, the desiccant seal 6 is also moved upward to expose a channel for solvent 41 to flow through the prefilled desiccant or drying agent 53. As shown in FIG. 10C, the solvent 41 is released from the valve dispenser 4 by depressing the plunger 11 against a surface. By depressing the plunger 11, force is applied to the internal spring 14 that moves the plunger seal 10 upwards to expose a channel for the solvent 41 that contains the chemical of interest to exit the valve dispenser 4.

In various examples, an inexpensive, contained, simple-to-use device is provided to perform in-field, liquid-liquid or solid-liquid extractions from solid samples. An important driver is the analysis of fentanyl in tablets and powders where cutting agents make up the bulk of the mass. Police and hazmat responders do not have availability of laboratory equipment or chemicals. In some embodiments, the device provides all that is needed to prepare a sample for in-field analysis. The volume of chemicals is low and can be contained for disposal or evidence retention.

Although implementations have been described above with a certain degree of particularity, those skilled in the art could make numerous alterations to the disclosed embodiments without departing from the spirit or scope of this invention. For example, although various embodiments may be described with respect to solid-liquid extraction or liquid-liquid extractions, each embodiment may be used for liquid-liquid extraction or solid-liquid extraction, respectively, by varying the number and/or types of solvents. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A device adapted to prepare a sample for testing, the device comprising:
a sealed container comprising an opening adapted to receive a solid sample and a reservoir comprising a solvent or adapted to receive a solvent, the reservoir adapted be provide for the solid sample and the solvent to be mixed in the reservoir and to concentrate at least one component of the sample into the solvent within the reservoir, and the reservoir being adapted to provide for the concentrate to be settled into a solvent layer within the container; and
a sample port adapted to sample the concentrate from within the solvent layer.

2. The device of claim 1 wherein the solid sample comprises at least one of a powder sample, a tablet sample, and an undivided solid sample.

3. The device of claim 2 wherein the solid sample comprises a tablet sample or an undivided sample, and the device is adapted to convert the tablet sample or the undivided solid sample into a powder sample.

4. The device of claim 3 wherein the sealed container comprises a receptacle adapted to receive the tablet sample or undivided solid sample and convert the tablet sample or undivided solid sample into the powder sample and a liquid chamber coupled to the receptacle adapted to receive the powder sample and mix the powder sample with the solvent.

5. The device of claim 1 wherein the solvent is disposed within a sealed ampoule disposed within the container.

6. The device of claim 1 wherein the reservoir is adapted to receive the sample via a port of the container.

7. The device of claim 1 wherein the sealed container comprises the solvent and a second solvent immiscible with the solvent.

8. The device of claim 7 wherein the solvent comprises an aqueous liquid.

9. The device of claim 8 wherein the solvent is disposed within a first sealed ampoule and the second solvent is disposed with a second sealed ampoule.

10. The device of claim 1 wherein the sealed container comprises at least one port adapted for receiving the solvent.

11. The device of claim 1 wherein the sealed container comprises a first seal and a second seal disposed in two locations.

12. The device of claim 12 wherein the first seal is accessible for receiving the solid sample as a tablet sample or an undivided solid sample and the second seal is accessible for sampling the concentrate.

13. The device of claim 12 wherein the first and second seals are sealed via removable clamps.

14. The device of claim 1 wherein the sample port comprises a dispensing tip.

15. The device of claim 14 wherein the dispensing tip is disposed on a bottom of the sealed container.

16. The device of claim 1 wherein the sample port is disposed on a bottom of the sealed container.

17. The device of claim 1 wherein sealed chamber comprises a prepackaged aqueous liquid ampoule and a prepackaged second solvent ampoule.

18. The device of claim 17 wherein the sealed chamber is adapted to facilitate crushing the prepackaged aqueous liquid ampoule and the prepackaged solvent ampoule through a wall of the sealed container to release the aqueous liquid and the solvent.

19. The device of claim 1 wherein the sealed chamber is adapted to facilitate crushing the pill through a wall of the container.

20. The device of claim 1 wherein the solvent comprises an organic solvent.

21. The device of claim 1 wherein the sealed chamber is adapted for receiving a powder solid sample.

22. The device of claim 1 wherein the sealed chamber is adapted to facilitate thorough mixing of the powder sample and the solvent.

23. The device of claim 22 wherein the sealed chamber is adapted to facilitate mixing through at least one wall of the sealed chamber.

24. The device of claim 1 wherein the sealed container comprises a mixing chamber and a separatory chamber, wherein a seal in the sealed container is adapted to facilitate delivering the mixed liquid to the separatory chamber for settling.

25. The device of claim 1 wherein the sample port is adapted to allow fluid from the layer to be deposited onto an analysis surface or into an analysis chamber.

26. The device of claim 1 wherein the container comprises a vessel adapted to settle the concentrate into the solvent layer.

27. The device of claim 26 wherein the vessel comprises a separatory funnel.

28. The device of claim 1 wherein the sample port comprises a valve dispenser.

29. The device of claim 28 wherein the valve dispenser comprises a desiccant.

30. The device of claim 28 wherein the valve dispenser is biased in a closed position.

31. The device of claim 30 wherein the valve dispenser is biased in the closed position via at least one spring.

32. The device of claim 30 wherein the bias of the valve dispenser is overcome by applying pressure to a holder of the valve dispenser to dispense a sample from the solvent layer.

33. The device of claim 1 wherein a desiccant is disposed within the reservoir.

34. A device for preparing a sample for testing, the device comprising:
a receptacle adapted to receive a solid sample;
a liquid chamber adapted to receive the solid sample and mix the solid sample with a solvent; and
a sample port for sampling a layer formed within the liquid chamber.

35. The device of claim 34 wherein the solid sample comprises at least one of a powder sample, a tablet sample, and an undivided solid sample.

36. The device of claim 35 wherein the solid sample comprises a tablet sample or an undivided sample, and the device is adapted to convert the tablet sample or the undivided solid sample into a powder sample.

37. The device of claim 36 wherein the receptacle is adapted to convert the tablet sample to the powder sample via at least one of the group comprising: comprises at least one of grinding, crushing, abrading, and cutting the tablet sample.

38. The device of claim 34 wherein the sample port is disposed at a bottom of the liquid chamber.

39. The device of claim 34 wherein the sample port is disposed at a top of the liquid chamber.

40. A method for preparing a sample for testing, the method comprising:
receiving a solid sample in a device;
introducing the solid sample to a solvent in the device;
creating a solution by mixing the solid sample with the solvent in the device to provide a solvent solution;
allowing the solvent solution to settle into at least one layer; and
sampling within the at least one layer.

41. The method of claim 40 further comprising concentrating one or more material of the solid sample into the solvent.

42. The method of claim 40 wherein a second solvent immiscible with the solvent is provided and the solvent solution is mixed with the second solvent.

43. The method of claim 42 wherein solvent and second solvent settle into a plurality of layers.

44. The method of claim 43 wherein the operation of sampling is performed within the layer corresponding to the second solvent.

45. The method of claim 40 wherein the solid sample comprises at least one of a powder sample, a tablet sample, and an undivided solid sample.

46. The method of claim 45 wherein the solid sample comprises a tablet sample or an undivided sample, and the device is adapted to convert the tablet sample or the undivided solid sample into a powder sample.

47. The method of claim 46 wherein the receptacle is adapted to convert the tablet sample to the powder sample via at least one of the group comprising: comprises at least one of grinding, crushing, abrading, and cutting the tablet sample.

48. The method of claim 40 comprising introducing a second solvent immiscible to the solvent to provide a solvent solution in the device.

49. The method of claim 40 wherein the solid sample comprise a fentanyl tablet.

50. The method of claim 40 wherein the second solvent comprises an organic solvent.

51. The method of claim 40 wherein the at least on layer is disposed at a bottom of a liquid receptacle of the device.

52. The method of claim 40 wherein the at least on layer is disposed at a top of a liquid receptacle of the device.

53. A device adapted to prepare a sample for testing, the device comprising:
a sealed container adapted to receive a solid sample comprising at least one of a tablet sample, an undivided solid sample and a powder sample, mix the powder sample with a solvent, concentrate at least one component of the powder sample into the solvent; and settle the concentrate into a solvent layer within the container; and
a sample port adapted to sample the concentrate from within the layer.

54. The device of claim 53 wherein the solid sample comprises a tablet sample or an undivided solid sample and the device is adapted to convert the tablet sample or undivided solid sample into a powder sample for mixing with the solvent.

55. The device of claim 53 wherein device comprises or is adapted to receive a second solvent immiscible with the solvent.

56. The device according to claim 53 wherein the container comprises a separating vessel adapted to concentrate at least one component of the sample into a solvent layer within the container.

57. The device of claim 56 wherein the separating vessel comprises a separatory funnel.
